(19) United States
(12) Patent Application Publication
(10) Pub. No.: US 2018/0346334 A1
(43) Pub. Date: Dec. 6, 2018

(54) PHOSPHATE COMPOUNDS SUITABLE FOR THE PRODUCTION OF CATHODES FOR LI-ION BATTERIES

(71) Applicant: Chemische Fabrik Budenheim KG, Budenheim (DE)

(72) Inventors: Christian GRAF, Mainz (DE); Daniel BUCHOLD, Ingelheim (DE); Kilian SCHWARZ, Mainz (DE); Michael RAPPHAHN, Eschborn (DE)

(73) Assignee: Chemische Fabrik Budenheim KG, Budenheim (DE)

(21) Appl. No.: 15/527,796

(22) PCT Filed: Dec. 9, 2015
(86) PCT No.: PCT/EP2015/079060

§ 371 Date: May 18, 2017

(30) Foreign Application Priority Data
Dec. 17, 2014 (DE) 10 2014 118 907.8

(51) Int. Cl. C01B 25/45; H01M 4/58

(52) U.S. Cl. CPC C01B 25/45; H01M 10/052; H01M 4/5825

(57) ABSTRACT

A crystalline, amorphous or mixed crystalline and amorphous phosphate compound of the type (M1ₐM2_{b}M3_{c}M4_{d})₃(PO₄)₂.xH₂O with 0<a<1, 0<b<1, 0<c<1, 0<d<1, a+b+c+d=1 and 0<x<8, wherein M1, M2 and M3 are metals selected from Mn, Fe, Co or Ni, and M4 is one or more metals selected from Sc, Ti, V, Cr, Mn, Fe, Co, Ni, Cu, Zn, Be, Mg, Ca, Sr, Ba, Al, Zr or La and process for the production thereof.

### SUBJECT-MATTER OF THE INVENTION

The invention concerns a process for the production of crystalline, amorphous or a mixture of crystalline and amorphous phosphate compounds of the type (M1ₐM2_{b}M3_{c}M4_{d})₃(PO₄)₂.xH₂O with 0≤a≤1, 0≤b≤1, 0≤c≤1, 0≤d≤1, a+b+c+d=1 and 0≤x≤8, wherein M1, M2 and M3 are metals from the group consisting of Mn, Fe, Co and Ni, and M4 is one or more metals from the group consisting of Sc, Ti, V, Cr, Mn, Fe, Co, Ni, Cu, Zn, Be, Mg, Ca, Sr, Ba, Al, Zr and La.

### BACKGROUND OF THE INVENTION

Rechargeable Li-ion batteries are widespread energy storage devices, in particular in the area of mobile electronics. Lithium metal oxides like for example LiCoO₂, LiNiO₂, LiNi₁₋ₓCoₓO₂ and LiMn₂O₄ have become established as cathode materials. Besides the oxides, suitable lithium-bearing phosphates have also been developed as cathode materials, like compounds of the type LiMPO₄ with M=Fe, Mn, Ni or Co and solid solutions thereof, for example LiFeₓMn_{y}PO₄ with x+y=1 and LiFeₓMn_{y}M_{z}PO₄ with x+y+z=1 and M=in particular Mg which are discussed as promising candidates for the replacement of pure LiFePO₄ in cathode materials as it is possible to achieve a higher energy storage density by virtue of the higher working voltage of compounds containing manganese or nickel or cobalt respectively in comparison with iron-bearing olivines.

DE 10 2009 001 204 describes a process for the production of crystalline iron (III)orthophosphate dehydrate (FOP) with a phosphosiderite or metastrengite II crystal structure which by virtue of the production process and the material properties is highly suitable as a precursor compound (precursor) for the production of LiFePO₄ in accordance with the processes described in the literature.

DE 10 2011 056 812 describes a process for the production of a mono-metallic or mixed-metallic phosphate of the type (M1 M2 M3 . . . Mx)₃(PO₄)₂.aH₂O by neutralisation of a phosphoric acid solution containing corresponding metal ions. In all cases neutralisation is effected with basic solutions containing alkali metal ions. As the alkali metal ions however can occupy lattice sites of lithium ions in the later cathode material they reduce the efficiency, service life and capacity of such a cathode material.

WO 97/40541, U.S. Pat. No. 5,910,382 and WO 00/60680 describe the production of lithium mixed metal phosphates, wherein generally firstly physical mixtures are produced from various metal salts or also organometallic compounds, which in a subsequent step are calcined with conventional methods of solid state synthesis at high temperatures and optionally with atmosphere control. In general in that respect the starting compounds are broken up in such a way that only the desired ions remain for construction of the target compound in the reaction system. A disadvantage with those processes is the high energy input required for the reaction, linked to high process costs. The product quality is frequently also not satisfactory as homogeneous distribution of the components is not achieved and the particle morphology is also not to be controlled.

CA 02443725 describes the production of LiXYPO4(X, Y=metal, for example Fe, Mn etc.) using iron sulphate, manganese sulphate and lithium phosphate and additionally lithium hydroxide as starting materials, from which firstly a solid mixture which is not characterised in greater detail is produced, which is subsequently converted into the desired product by a calcination step at 300 to 1000° C. By virtue of the use of sulphates the product is to be subjected to an intensive washing procedure in order to reduce the sulphate content to a tolerable extent whereby lithium is in turn taken from the product.

In principle it is possible to achieve quite homogeneous cation distributions by hydro- or solvothermal processes if the solubilities and complexing constants or the crystal growth factors of the introduced cations and anions can be controlled and adjusted over the reaction procedure in the selected matrix in such a way that exclusively the desired species is produced in isolatable form. In many cases surface-active substances or also adjuvants which promote the production of a given crystal phase or growth in a preferred direction, so-called templates which are known to the man skilled in the art, are used here to control crystal growth. In those processes operation is often implemented in closed systems beyond the boiling point of the reaction matrix, whereby very high pressures are involved. That places high demands on reactor technology. The products obtained nonetheless or in addition often have to be subsequently calcined to ensure the necessary crystallinity. The surface-active additives also have to be quantitatively removed in order not to cause negative influences in later use. That is also achieved by heating, in which case those substances burn or char or soot.

Processes which operate in a pressure-less mode are also described, wherein the crystallisation times of the desired products are always specified as a plurality of days to weeks. That puts the economic viability in doubt in a commercial use.

Particularly high purity demands are placed on the starting materials used for the production of cathode materials for Li-ion batteries as impurities which remain in the product in production can lead to losses in efficiency of the cathode material of the Li-ion batteries. Such efficiency-impairing impurities are in particular chlorides and sulphates which are frequently introduced into the product by way of the starting compounds in the production procedure. To reduce such impurities in the product to a tolerable extent the product has to be subjected to an intensive washing process. As a result however a considerable amount of lithium can also be taken from the product as only trilithium orthophosphate has a very low degree of solubility among the lithium orthophosphates.

### OBJECT

The object of the present invention was to provide a process for the production of mixed-metallic phosphates, which is comparatively energy-efficient and simple and with which the phosphates can be produced in a high state of purity, in particular in relation to troublesome foreign ions, so that in comparison with the state of the art they are better suited for example as precursor compounds (precursors) for the production of lithiated cathode materials for lithium ion batteries.

### DESCRIPTION OF THE INVENTION

The object according to the invention is attained by a process for the production of crystalline, amorphous or mixed crystalline-amorphous phosphate compounds of the type (M1ₐM2_{b}M3_{c}M4_{d})₃(PO₄)₂.xH₂O with 0≤a≤1, 0≤b≤1, 0≤c≤1, 0≤d≤1, a+b+c+d=1 and 0≤x≤8, wherein M1, M2 and M3 are metals from the group consisting of Mn, Fe, Co and Ni, and M4 is one or more metals from the group consisting of Sc, Ti, V, Cr, Mn, Fe, Co, Ni, Cu, Zn, Be, Mg, Ca, Sr, Ba, Al, Zr and La, and

wherein the process is characterised in that

a) a first aqueous solution (I) is prepared, which contains divalent cations of at least one or more of the metals M1, M2 and M3 and carboxylate anions,

wherein at least one or more of the metals M1, M2 and M3 is dissolved in elementary form or in the form of alloys thereof in carboxylic acid (HX) or an aqueous solution of carboxylic acid (HX), and

optionally at least one further metal M4 is added in the form of a metal compound selected from the group consisting of hydroxides, oxides, oxide hydroxides, oxide hydrates, carbonates, hydroxide carbonates, carboxylates, sulphates, chlorides and nitrates, wherein the addition is effected in the form of an aqueous solution of the metal compound or as a solid,

b) a second phosphoric acid aqueous solution (II) is prepared, with a phosphoric acid concentration in the range of 5 to 85% by weight, which optionally contains divalent cations of at least one or more of the metals M1, M2 and M3,

wherein the divalent cations are introduced into the solution by dissolving at least one oxygen-bearing metal compound selected from hydroxides, oxides, oxide hydroxides, oxide hydrates, carbonates and hydroxide carbonates of at least one or more of the metals M1, M2 and M3 in aqueous phosphoric acid, and

optionally at least one further metal M4 is added in the form of a metal compound selected from the group consisting of hydroxides, oxides, oxide hydroxides, oxide hydrates, carbonates, hydroxide carbonates, carboxylates, sulphates, chlorides and nitrates, wherein the addition is effected in the form of an aqueous solution of the metal compound or as a solid,

c) the solutions (I) and (II) are combined with precipitation of the phosphate compound of type (M1ₐM2_{b}M3_{c}M4_{d})₃(PO₄)₂.xH₂O.

The process according to the invention provides high-purity mixed-metallic phosphates which are suitable in particular as precursors for further reaction to afford lithium metal phosphates for use as cathode materials for lithium-ion batteries. The process does not require the use of alkali metal ion-containing basic solutions for raising the pH-value. With the process according to the invention the buffer action of the acids in the solutions (I) and (II) is put to use to adjust the pH-value in the course of combining the solutions (I) and (II) into a range which is optimum for the phosphate precipitation reaction and to keep it there.

The carboxylic acid (HX) in solution (I) dissolves the metals used in accordance with the following system oxidatively or redox-chemically:

2HX+M→{M²⁺;2X⁻}_{aq}+H₂↑ M=metal, HX=carboxylic acid

The metal ions (M²⁺) dissolved in the carboxylic acid (HX) of the solution (I) are then precipitated by combining with the phosphoric acid aqueous solution (II), in which case the mixture of metal salt-salt {M²⁺; 2×X⁻}_{aq} and free acid (HX) forms a buffer system which keeps the pH-value of the resulting solution substantially constant:

5{M²⁺;2X⁻}_{aq}+2H₃PO₄→M₃(PO₄)₂.xH₂O↓+2{M²⁺;2X⁻}_{aq}+6HX

The resource-saving and inexpensive process according to the invention makes it possible to produce an alkali-free material of high purity.

That procedure is particularly economical in an implementation in which operation is effected with an excess of dissolved metal ions and a stoichiometric amount of phosphoric acid is used to precipitate the desired phosphate. The remaining or recovered carboxylic acid HX can then be recycled to the process again for dissolving metal and for production of the solution (I). The recycling of the carboxylic acid HX gives rise to no amounts or only slight amounts of by-products or waste products, which permits a particularly economic and resource-sparing procedure.

The mixed-metallic phosphate according to the invention (M1ₐM2_{b}M3_{c}M4_{d})₃(PO₄)₂.xH₂O can be further reacted with a suitable lithium source to give a mixed-metallic lithium metal phosphate. It is particularly advantageous for that purpose to suspend the precipitate of (M1ₐM2_{b}M3_{c}M4_{d})₃(PO₄)₂.xH₂O in dilute phosphoric acid and to mix it with an aqueous solution of LiOH.H₂O. In that case lithium phosphate is formed, which is homogeneously precipitationed on the mixed-metallic phosphate:

H₃PO₄+3LiOH.H₂O→Li₃PO₄+6H₂O

That process has the advantage that the lithium phosphate is distributed homogeneously on the mixed-metallic phosphate and lithium, metal component and phosphate can be provided in an optimum relationship with each other for further reaction to give a lithium metal phosphate:

(M1ₐM2_{b}M3_{c}M4_{d})₃(PO₄)₂.xH₂O+Li₃PO₄→3Li(M1ₐM2_{b}M3_{c}M4_{d})PO₄+xH₂O

Due to the equimolar ratio of lithium, phosphorus and the sum of the metals M1, M2, M3 and M4, no further addition of compounds containing phosphorus or lithium is necessary, and that represents a considerable simplification in the above-mentioned subsequent procedure.

In addition, in the formation of lithium phosphate, on the mixed-metallic phosphate precursor, a carbon source can be introduced into the aqueous solution, which in the thermal reaction of the material forms a homogeneous carbon layer which provides for improved electrochemical properties of the cathode material.

In accordance with the present invention the term mixed crystalline-amorphous phosphate compound means that the phosphate compound is present in the form of a mixture with crystalline and amorphous proportions of the phosphate compound. The crystallinity of a compound is usually assessed on the basis of the X-ray diffractogram, wherein wide peaks involving lesser intensities indicate a lesser or poorer crystallinity than narrow peaks with higher intensities. It is also to be noted however that the width and intensity of the peaks can also be influenced by the morphology of the material being tested. Thus a flaky morphology of the crystalline material with particle sizes in the nanometre range can lead to peak widening and/or intensity reduction in comparison with other morphologies. The man skilled in that field however knows he has to take that into consideration.

The concentration of the phosphoric acid in solution (II) is in the range of 5 to 85% by weight. If the concentrations are too low then under some circumstances the metal ions optionally contained in solution (II) may not be dissolved. If the concentration is too high the process can become technically complicated and expensive and therefore possibly uneconomical by virtue of a high viscosity for the solution.

In an embodiment of the process according to the invention the carboxylic acid (HX) in step a) is selected from the group consisting of formic acid, acetic acid, propionic acid, butyric acid, valeric acid, hexanoic acid, heptanoic acid, octanoic acid, nonanoic acid, decanoic acid and acrylic acid, wherein the carboxylic acid (HX) in step a) is preferably acetic acid.

In a further embodiment of the process according to the invention the carboxylic acid (HX) in step a) is used in the form of an aqueous solution with a concentration of 5 to 50% by weight, preferably 10 to 30% by weight, of carboxylic acid.

Those concentration ranges of the aqueous carboxylic acid solution have proven to be advantageous for rapidly and substantially completely dissolving the divalent metal cations M1, M2 and/or M3. With an excessively low concentration of the aqueous carboxylic acid solution dissolution of the divalent metal cations is possibly not complete and does not take place at an acceptable speed. An excessively high concentration of the aqueous carboxylic acid solution can lead to a reduction in yield and precipitation of impure phases in the end product. With an excessively high concentration the dissolution of the metal cations in the aqueous carboxylic acid solution can also entail technical difficulties as the reaction takes place exothermally and takes place more quickly with a higher carboxylic acid solution concentration.

In a further embodiment of the process according to the invention in step c) the solutions (I) and (II) are combined with precipitation of the phosphate compound of type (M1ₐM2_{b}M3_{c}M4_{d})₃(PO₄)₂.xH₂O by providing an amount of the solution (I) or (II) and meteredly adding the respective other solution (II) or (I) to the provided solution.

Depending on the respectively desired ratio of M1, M2, M3 and M4 and the distribution thereof in solution (I) and (II) there can be advantages in respect of process technology, in presenting the solution with the greater volume. The provision of an excessively small volume can involve disadvantages in terms of process technology upon homogenisation and detection of measurement parameters. It was further found that the metering rate appears to have an influence on the formation of the phases. Metered addition of the one solution to the respective other solution within a period of about 10 to 20 minutes has proven to be advantageous.

In a further embodiment of the process according to the invention a carbon source is admixed to one or both of the solutions (I) or (II) before combination in step c) or upon combination of the solutions (I) and (II) in step c) a carbon source is admixed in the form of a separate solution, dispersion or suspension, wherein the carbon source is selected from the group consisting of elementary carbon, organic compounds or mixtures thereof, preferably consisting of graphite, expanded graphite, carbon black, pine soot, carbon nanotubes (CNT), fullerenes, graphenes, glassy carbon, carbon fibres, activated carbon, hydrocarbons, alcohols, aldehydes, carboxylic acids, surfactants, oligomers, polymers, carbohydrates or mixtures thereof. Desirably the carbon source is added in an amount which is 1 to 10% by weight of carbon, preferably 1.5 to 5% by weight of carbon, particularly preferably 1.8 to 4% by weight of carbon, with respect to the weight of precipitated phosphate compound. That has advantages in regard to a later reaction to give lithium metal phosphate as a cathode material for lithium-ion batteries as adequate conductivity of the material is guaranteed in that range without introducing an excessively high inactive mass.

In a further embodiment of the process according to the invention the phosphoric acid aqueous solution (II) is produced with a phosphoric acid concentration in the range of 5 to 70% by weight, preferably 10 to 60% by weight, particularly preferably 15 to 40% by weight. That has advantages in regard to the process and product properties like yield, solids proportion, particle size distribution and chemical composition.

In a further embodiment of the process according to the invention the combination of the solutions (I) and (II) with precipitation of the phosphate compound of type (M1ₐM2_{b}M3_{c}M4_{d})₃(PO₄)₂.xH₂O in step c) is carried out at a temperature of the solutions (I) and (II) in the range of 15° C. to 90° C., preferably in the range of 20° C. to 75° C., particularly preferably in the range of 25° to 65° C. That has advantages in regard to the process and product properties like yield, solids proportion, particle size distribution and chemical composition.

In a further embodiment of the process according to the invention the phosphate compound precipitated in step c) of type (M1ₐM2_{b}M3_{c}M4_{d})₃(PO₄)₂.xH₂O is separated off by filtration, centrifuging or sedimentation from the solution and the solution (filtrate, centrifugate) freed of the precipitated phosphate compound is returned to step a) of the process.

In a further embodiment of the process according to the invention undissolved solids are separated from the first aqueous solution (I) produced in step a), the second phosphoric acid aqueous solution (II) produced in step b) or from both solutions (I) and (II) prior to combination in step c).

In a further embodiment of the process according to the invention the concentration of the metals M1, M2 and M3 in the first aqueous solution (I) is so adjusted that the solution (I) contains the metal ions before step c) in a concentration of 0.2 to 3.5 mol/l, preferably 0.8 to 2.0 mol/l, further preferably 1.0 to 1.7 mol/l, particularly preferably 1.1 to 1.3 mol/l. That has advantages in regard to the morphology and particle size of the product.

The invention also embraces a crystalline, amorphous or mixed crystalline-amorphous phosphate compound of the type (M1ₐM2_{b}M3_{c}M4_{d})₃(PO₄)₂.xH₂O with 0≤a≤1, 0≤b≤1, 0≤c≤1, 0≤d≤1, a+b+c+d=1 and 0≤x≤8, wherein M1, M2 and M3 are metals from the group consisting of Mn, Fe, Co and Ni, and M4 is one or more metals from the group consisting of Sc, Ti, V, Cr, Mn, Fe, Co, Ni, Cu, Zn, Be, Mg, Ca, Sr, Ba, Al, Zr and La produced according to the process according to the invention as is described herein.

In a preferred embodiment of the invention the phosphate compound has a flaky morphology with a mean thickness of the crystallites of <1000 nm, preferably <500 nm, particularly preferably <100 nm, quite particularly preferably <50 nm.

In a further preferred embodiment of the invention the phosphate compound has a content of sodium and potassium of respectively <300 ppm, preferably <200 ppm, particularly preferably <100 ppm and/or the phosphate compound has a sulphur content of <300 ppm, preferably <200 ppm, particularly preferably <100 ppm and/or the phosphate compound has a chlorine content of <300 ppm, preferably <200 ppm, particularly preferably <100 ppm and/or the phosphate compound has a nitrate content of <300 ppm, preferably <200 ppm, particularly preferably <100 ppm.

The invention further embraces the use of the phosphate compound according to the invention as it is described herein as a precursor compound for the production of cathode material for Li-ion batteries.

The invention further embraces a process for the production of a cathode material for Li-ion batteries, in which an Li compound is reacted with a phosphate compound according to the invention.

Finally the invention also embraces a process for the production of crystalline, amorphous or mixed crystalline-amorphous phosphate compounds of the type NH₄(M1ₐM2_{b}M3_{c}M4_{d})PO₄.xH₂O according to claim 15 as well as a product produced by the process according to claim 15. Advantageous configurations of the process according to claim 15 and the product produced thereby are afforded similarly to claims 2 to 10 and claims 12 and 13.

### EXAMPLES

### Example 1

### Production of Mn₃(PO₄)₂.3H₂O

218.8 g of 80% acetic acid was diluted with 781.3 g of deionised water giving 17.5% acetic acid and then mixed with 53 g of elementary. Mn in the form of chips and agitated until a clear solution was produced. Thereafter the solution was filtered to remove suspended substances. The resulting Mn²⁺ acetate solution was mixed with 55.7 g of a 75% phosphoric acid. A light pink precipitate was formed, which was then separated from the solution by means of a suction Nutsche filter. The precipitate was washed and dried under an air atmosphere for 12 hours at 120° C. The yield was 72.9 g of a dry pink-coloured product. The product was identified by electron microscopic (FIG. 1a) and radiographic (FIG. 1b) investigations as Mn₃(PO₄)₂.3H₂O.

### Example 2

### Production of Mn₃(PO₄)₂.3H₂O with Recycling of the Carboxylic Acid

The filtrate from Example 1 was mixed with 37.1 g of elementary Mn in the form of chips and agitated for 2 hours. Similarly to Example 1 the resulting Mn²⁺ acetate solution was mixed with 55.7 g of a 75% phosphoric acid. A light pink precipitate was again formed, which was then separated from the solution by means of a suction Nutsche filter. The precipitate was washed and dried in an air atmosphere for 12 hours at 120° C. The yield was 72.9 g of a dry pink-coloured product. Similarly to Example 1 the product was identified as Mn₃(PO₄)₂.3H₂O.

Although this Example added less elementary Mn than Example 1 the yield was as great as in Example 1. The reason for this is an excess of Mn²⁺ ions in the precipitation operation in Example 1 so that Mn²⁺ ions were still contained in the solution (the filtrate) after separation of the precipitated product. Therefore, in recycling of the filtrate, a smaller amount of Mn had to be used to achieve the same Mn concentration in the Mn²⁺ acetate solution. After the subsequent precipitation with phosphoric acid Mn again remained in the solution, which explains that the same yield was achieved as in Example 1.

### Example 3

### Production of (Fe_{0.25}Mn_{0.75})₃(PO₄)₂.3H₂O

1200 g of 12.5% acetic acid was mixed with 63 g of Mn chips and agitated until a clear solution was produced. After that the solution was filtered to remove suspended substances. Similarly to DE 10 2009 001 204 a phosphoric acid Fe²⁺ solution with an iron content of 6.2% and a phosphoric acid concentration of 30% was produced from 13 g of Fe₂O₃ and 8 g of Fe. The phosphoric acid Fe solution was heated to 80° C. and the previously produced Mn acetate solution was slowly added. After addition was completed the reaction solution was boiled for 10 minutes. A yellowish-green precipitate was formed, which was then separated from the solution by means of a suction Nutsche filter. The precipitate was washed and dried in an air atmosphere for 12 hours at 120° C. The yield was 151.2 g of a dry pink-coloured product. The ratio ascertained by means of XRF analysis of Fe:Mn in the sample was 0.3. The product was identified as (Fe_{0.25}Mn_{0.75})₃(PO₄)₂.3H₂O by electron microscopic (FIG. 2a) and radiographic (FIG. 2b) investigations.

### Example 4

### Production of (Fe_{0.25}Mn_{0.75})₃(PO₄)₂.3H₂O with Recycling of the Carboxylic Acid

The filtrate from Example 3 was filled up with 12.5% acetic acid to give 1200 g and mixed with 50 g of Mn chips and agitated for 2 hours. Similarly to Example 3 a phosphoric acid Fe²⁺ solution with an iron content of 6.2% and a phosphoric acid concentration of 30% was produced from 13 g of Fe₂O₃ and 8 g of Fe. The phosphoric acid Fe solution was heated to 80° C. and the Mn acetate solution slowly added. After the addition was complete the reaction solution was boiled for 10 minutes. Once again a yellowish-green precipitation was formed, which was then separated from the solution by means of a suction Nutsche filter. The precipitate was washed and dried in an air atmosphere for 12 hours at 120° C. The yield was 148.0 g of a dry pink-coloured product. Similarly to Example 3 the product was identified as (Fe_{0.25}Mn_{0.75})₃(PO₄)₂.3H₂O.

### Example 5

### Production of LiFe_{0.25}Mn_{0.75}PO₄

The product of Example 3 was mixed with Li₂CO₃, NH₄H₂PO₄ and sucrose in the ratio of 2:3:2:1. The mixture was then tempered at 700° C. for 12 hours under forming gas. A black powder was obtained, which could be identified as LiFe_{0.25}Mn_{0.75}PO₄ by means of electron microscopic (FIG. 3a) and radiographic (FIG. 3b) investigations. That was processed to give a dispersion with polyvinylidene fluoride (PVDF), carbon black and N-methyl-2-pyrrolidone (NMP) and then applied to an aluminium film. The resulting electrodes were used as a cathode in combination with a lithium electrode as an anode in button cells and electrochemically investigated (FIG. 3c and FIG. 3d).

### Example 6

### Production of Fe_{0.25}Mn_{0.75})₃(PO₄)₂.3H₂O.Li₃PO₄

Similarly to Example 3 phosphoric acid Fe solution was mixed with Mn acetate solution. That resulted in a yellowish-green precipitate which was filtered off. The solid was washed and then 8.69 g of the solid was suspended in 10.3 g of 20% phosphoric acid. An aqueous saturated LiOH solution was added to the suspension, that had been produced from 2.65 g of LiOH*H20. In that case a white precipitate was formed. The solid constituents were separated off by means of a suction Nutsche filter, washed and dried at 120° C. for 12 hours in an air atmosphere.

### Example 7

### Production of LiFe_{0.25}Mn_{0.75}PO₄

The product obtained in Example 6 was tempered under forming gas at 700° C. for 12 hours. A black powder was obtained, which could be identified as LiFe_{0.25}Mn_{0.75}PO₄ by means of electron microscopic (FIG. 4a) and radiographic (FIG. 4b) investigations.

### Example 8

### Production of NH₄MNPO₄.H₂O

Similarly to Example 1 a 15% acetic acid was mixed with Mn chips and agitated until a clear solution was produced. The solution was filtered to remove suspended substances. An ammonium phosphate solution was produced from ammonia and phosphoric acid. The ammonium phosphate solution was then mixed with the Mn solution and heated to 80° C. A yellowish-green precipitate was formed, which was then sucked away and well washed. The precipitate was dried at 120° C. for at least 12 hours in an air atmosphere. The product was identified as NH₄MnPO₄.H₂O by electron microscopic (FIG. 5a) and radiographic (FIG. 5b) investigations.

### DESCRIPTION OF THE FIGURES

FIG. 1a: Raster electron microscope image (REM) of the product of Example 1;

FIG. 1b: Powder X-ray diffraction diagram of the product of Example 1 with CuK α-radiation, completely indexable in accordance with PDF 003-0426;

FIG. 2a: Raster electron microscope image (REM) of the product of Example 3;

FIG. 2b: Powder X-ray diffraction diagram of the product of Example 3 with CuK α-radiation, completely indexable in accordance with PDF 003-0426;

FIG. 3a: Raster electron microscope image (REM) of the product of Example 5;

FIG. 3b: Powder X-ray diffraction diagram of the product of Example 5 with CuK α-radiation, completely indexable in accordance with PDF 01-073-7353;

FIG. 3c: Voltammetric measurement of material from Example 5;

FIG. 3d: Constant current cyclisation of material from Example 5;

FIG. 4a: Raster electron microscope image (REM) of the product of Example 7;

FIG. 4b: Powder X-ray diffraction diagram of the product of Example 7 with CuK α-radiation, completely indexable in accordance with PDF 001-089-7115;

FIG. 5a: Raster electron microscope image (REM) of the product of Example 8;

FIG. 5b: Powder X-ray diffraction diagram of the product of Example 8 with CuK α-radiation, completely indexable in accordance with PDF 050-0554.

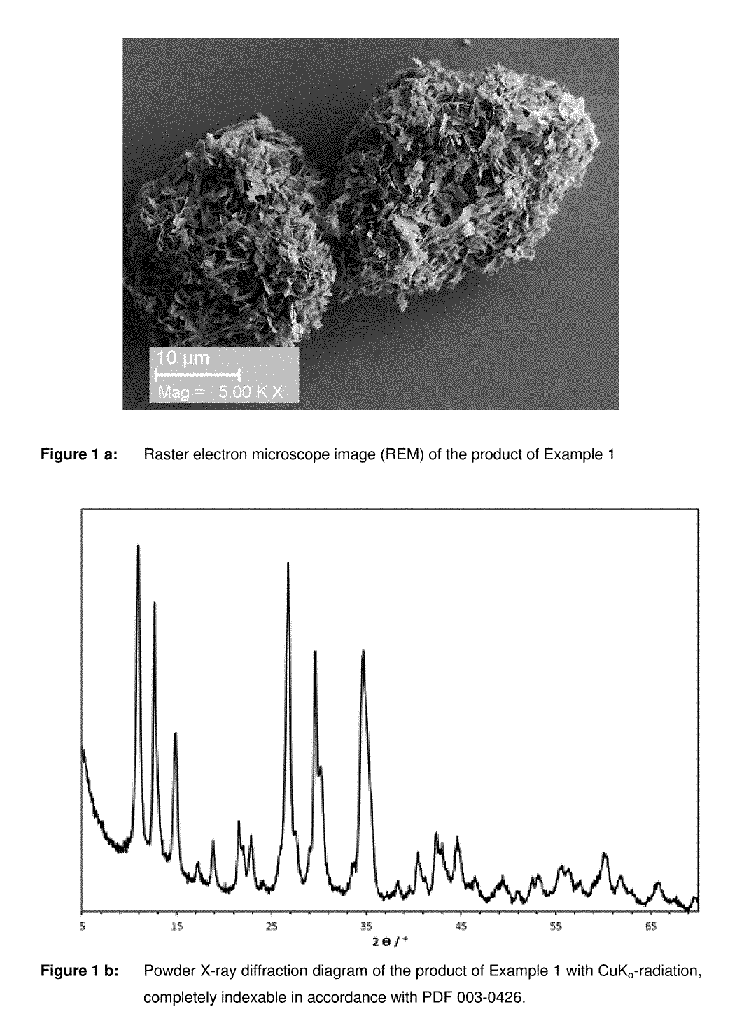

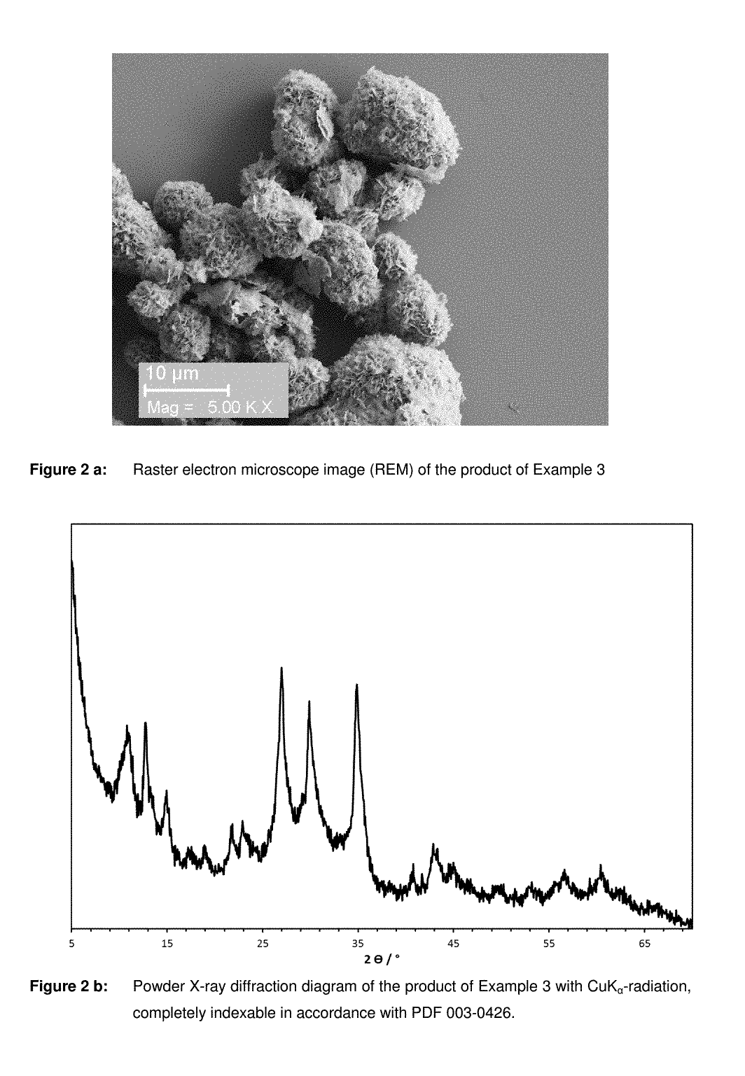

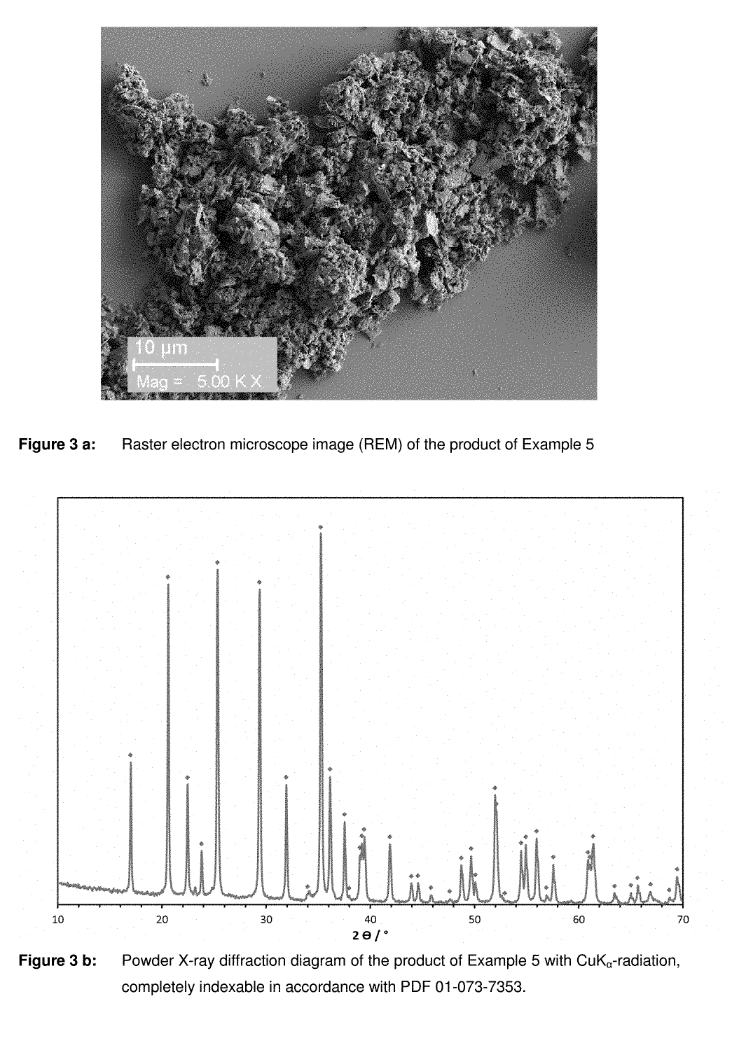

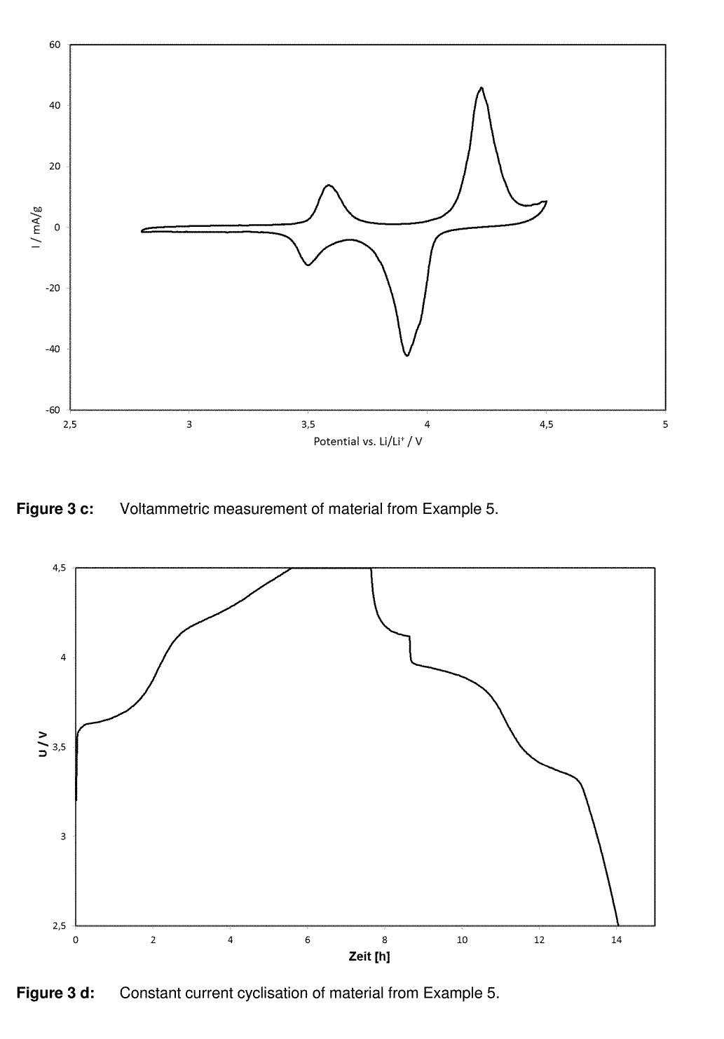

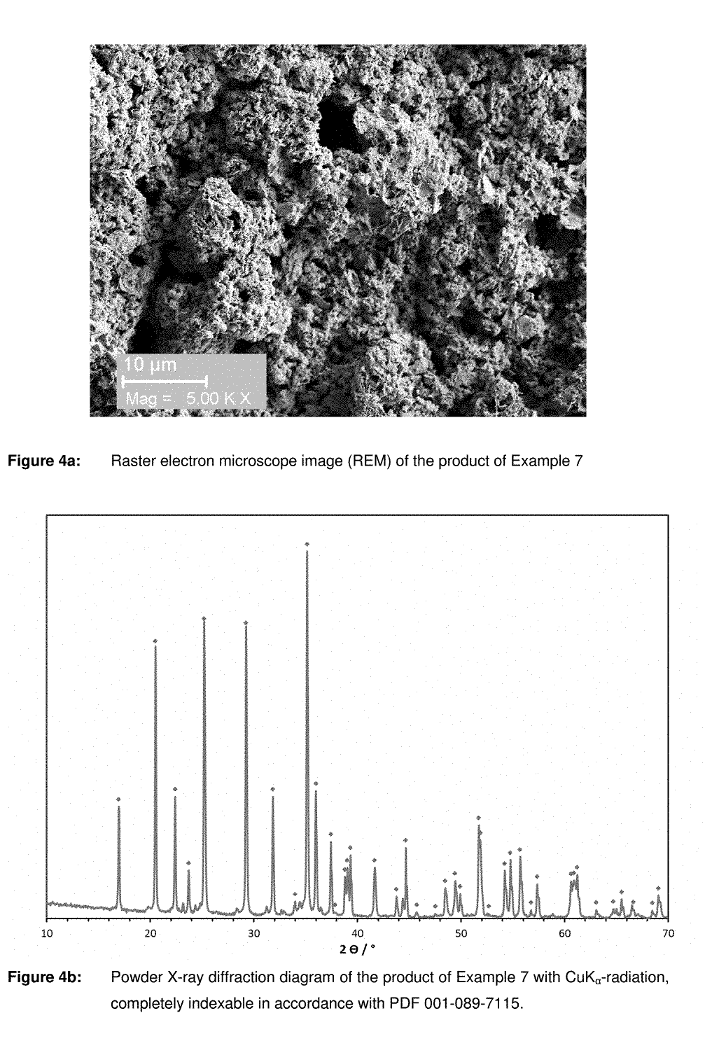

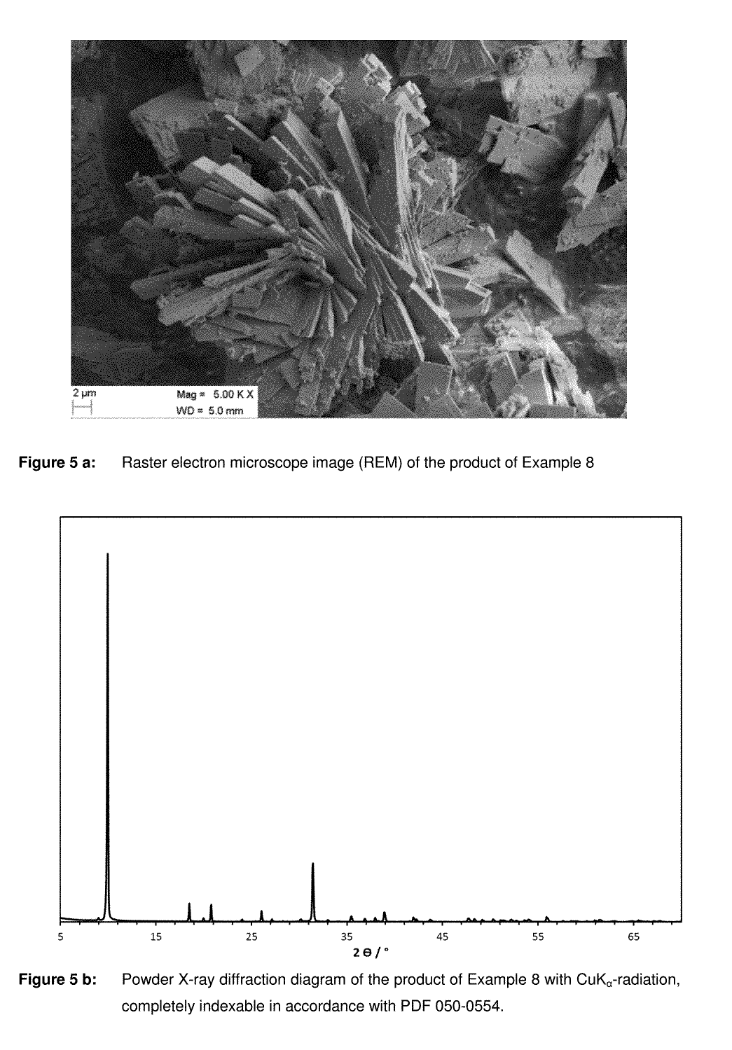

1. A process for the production of crystalline, amorphous or mixed crystalline-amorphous phosphate compounds of the type (M1ₐM2_{b}M3_{c}M_{d})₃(PO₄)₂.xH₂O with 0≤a≤1, 0≤b≤1, 0≤c≤1, 0≤d≤1, a+b+c+d=1 and 0≤x≤8, wherein M1, M2 and M3 are metals selected from the group consisting of Mn, Fe, Co and Ni, and M4 is one or more metals selected from the group consisting of Sc, Ti, V, Cr, Mn, Fe, Co, Ni, Cu, Zn, Be, Mg, Ca, Sr, Ba, Al, Zr and La,
comprising:
a) preparing a first aqueous solution (I), which contains divalent cations of at least one or more of the metals M1, M2 and M3 and carboxylate anions,
wherein at least one or more of the metals M1, M2 and M3 is dissolved in elementary form or in the form of alloys thereof in carboxylic acid (HX) or an aqueous solution of carboxylic acid (HX), and
optionally at least one further metal M4 is added in the form of a metal compound selected from the group consisting of hydroxides, oxides, oxide hydroxides, oxide hydrates, carbonates, hydroxide carbonates, carboxylates, sulphates, chlorides and nitrates, wherein the addition is effected in the form of an aqueous solution of the metal compound or as a solid;
b) preparing a second phosphoric acid aqueous solution (II), with a phosphoric acid concentration in the range of 5 to 85% by weight, which optionally contains divalent cations of at least one or more of the metals M1, M2 and M3,
wherein the divalent cations are introduced into the solution by dissolving at least one oxygen-bearing metal compound selected from the group consisting of hydroxides, oxides, oxide hydroxides, oxide hydrates, carbonates and hydroxide carbonates of at least one or more of the metals M1, M2 and M3 in aqueous phosphoric acid, and
optionally at least one further metal M4 is added in the form of a metal compound selected from the group consisting of hydroxides, oxides, oxide hydroxides, oxide hydrates, carbonates, hydroxide carbonates, carboxylates, sulphates, chlorides and nitrates, wherein the addition is effected in the form of an aqueous solution of the metal compound or as a solid; and
c) combining the solutions (I) and (II) with precipitation of the phosphate compound of type (M1ₐM2_{b}M3_{c}M4_{d})₃(PO₄)₂.xH₂O.

2. The process according to claim 1, wherein the carboxylic acid (HX) in step a) is selected from the group consisting of formic acid, acetic acid, propionic acid, butyric acid, valeric acid, hexanoic acid, heptanoic acid, octanoic acid, nonanoic acid, decanoic acid and acrylic acid.

3. The process according to claim 1, wherein the carboxylic acid (HX) in step a) is used in the form of an aqueous solution with a concentration of 5 to 50% by weight of carboxylic acid.

4. The process according to claim 1, wherein in step c) the solutions (I) and (II) are combined with precipitation of the phosphate compound of type (M1ₐM2_{b}M3_{c}M4_{d})₃(PO₄)₂.xH₂O by providing an amount of the solution (I) or (II) and meteredly adding the respective other solution (II) or (I) to the provided solution.

5. The process according to claim 1, wherein a carbon source is admixed to one or both of the solutions (I) or (II) before combination in step c) or upon combination of the solutions (I) and (II) in step c) a carbon source is admixed in the form of a separate solution, dispersion or suspension, wherein the carbon source is selected from the group consisting of elementary carbon, organic compounds or mixtures thereof.

6. The process according to claim 1, wherein the phosphoric acid aqueous solution (II) is produced with a phosphoric acid concentration in the range of 5 to 70% by weight.

7. The process according to claim 1, wherein combination of the solutions (I) and (II) with precipitation of the phosphate compound of type (M1ₐM2_{b}M3_{c}M4_{d})₃(PO₄)₂.xH₂O in step c) is carried out at a temperature of the solutions (I) and (II) in the range of 15° C. to 90° C.

8. The process according to claim 1, wherein the phosphate compound precipitated in step c) of type (M1ₐM2_{b}M3_{c}M4_{d})₃(PO₄)₂.xH₂O is separated off by filtration, centrifuging or sedimentation from the solution and the solution (filtrate, centrifugate) freed of the precipitated phosphate compound is returned to step a) of the process.

9. The process according to claim 1, wherein undissolved solids are separated from the first aqueous solution (I) produced in step a), the second phosphoric acid aqueous solution (II) produced in step b) or from both solutions (I) and (II) prior to combination in step c).

10. The process according to claim 1, wherein the concentration of the metals of M1, M2 and M3 in the first aqueous solution (I) is so adjusted that the solution (I) contains the metal ions before step c) in a concentration of 0.2 to 3.5 mol/l.

11. A crystalline, amorphous or mixed crystalline-amorphous phosphate compound of the type (M1ₐM2_{b}M3_{c}M4_{d})₃(PO₄)₂.xH₂O with 0≤a≤1, 0≤b≤1, 0≤c≤1, 0≤d≤1, a+b+c+d=1 and 0≤x≤8, wherein M1, M2 and M3 are metals selected from the group consisting of Mn, Fe, Co and Ni, and M4 is one or more metals selected from the group consisting of Sc, Ti, V, Cr, Mn, Fe, Co, Ni, Cu, Zn, Be, Mg, Ca, Sr, Ba, Al, Zr and La produced according to claim 1.

12. The phosphate compound according to claim 11, wherein the phosphate compound has a flaky morphology with a mean thickness of the crystallites of <500 nm.

13. The phosphate compound according to claim 11, wherein
the phosphate compound has a content of sodium and potassium of respectively <300 ppm and/or
the phosphate compound has a sulphur content of <300 ppm and/or
the phosphate compound has a chlorine content of <300 ppm and/or
the phosphate compound has a nitrate content of <300 ppm.

14. A method comprising producing cathode material for Li-ion batteries using the phosphate compound according to claim 11 as a precursor compound.

15. A process for the production of crystalline, amorphous or mixed crystalline-amorphous phosphate compounds of the type (M1ₐM2_{b}M3_{c}M4_{d})₃(PO₄)₂.xH₂O with 0≤a≤1, 0≤b≤1, 0≤c≤1, 0≤d≤1, a+b+c+d=1 and 0≤x≤8, wherein M1, M2 and M3 are metals selected from the group consisting of Mn, Fe, Co and Ni, and M4 is one or more metals selected from the group consisting of Sc, Ti, V, Cr, Mn, Fe, Co, Ni, Cu, Zn, Be, Mg, Ca, Sr, Ba, Al, Zr and La,
comprising:
a) preparing a first aqueous solution (I) is prepared, which contains divalent cations of at least one or more of the metals M1, M2 and M3 and carboxylate anions,
wherein at least one or more of the metals M1, M2 and M3 is dissolved in elementary form or in the form of alloys thereof in carboxylic acid (HX) or an aqueous solution of carboxylic acid (HX), and
optionally at least one further metal M4 is added in the form of a metal compound selected from the group consisting of hydroxides, oxides, oxide hydroxides, oxide hydrates, carbonates, hydroxide carbonates, carboxylates, sulphates, chlorides and nitrates, wherein the addition is effected in the form of an aqueous solution of the metal compound or as a solid;
b) preparing a second phosphoric acid aqueous solution (II) is prepared, with a phosphoric acid concentration in the range of 5 to 85% by weight, which contains ammonium ions (NH₄⁺), wherein the ammonium ions (NH₄⁺) are introduced into the solution by the addition of ammonia or an ammonium salt and wherein the second phosphoric acid aqueous solution (II) optionally contains divalent cations of at least one or more of the metals M1, M2 and M3,
wherein the divalent cations are introduced into the solution by dissolving at least one oxygen-bearing metal compound selected from hydroxides, oxides, oxide hydroxides, oxide hydrates, carbonates and hydroxide carbonates of at least one or more of the metals M1, M2 and M3 in aqueous phosphoric acid, and
optionally at least one further metal M4 is added in the form of a metal compound selected from the group consisting of hydroxides, oxides, oxide hydroxides, oxide hydrates, carbonates, hydroxide carbonates, carboxylates, sulphates, chlorides and nitrates, wherein the addition is effected in the form of an aqueous solution of the metal compound or as a solid; and
c) combining the solutions (I) and (II) are combined with precipitation of the phosphate compound of type NH₄(M1ₐM2_{b}M3_{c}M4_{d})PO₄.xH₂O.
